(19) United States
(12) Patent Application Publication
(10) Pub. No.: US 2024/0368779 A1
(43) Pub. Date: Nov. 7, 2024

(54) DEVICES, SYSTEMS, AND METHODS FOR HYDROGEN GENERATION, COLLECTION, AND DISTRIBUTION

(71) Applicant: OCEANA ENERGY COMPANY, Washington, DC (US)

(72) Inventors: Daniel E. POWER, III, Pace, FL (US); Mark E. WHALEN, Rochester, MA (US)

(73) Assignee: OCEANA ENERGY COMPANY, Washington, DC (US)

(21) Appl. No.: 18/687,361

(22) PCT Filed: Aug. 30, 2022
(86) PCT No.: PCT/US2022/041996

§ 371 Date: Feb. 28, 2024

Related U.S. Application Data
(60) Provisional application No. 63/238,538, filed on Aug. 30, 2021.

(51) Int. Cl. C25B 9/65; C25B 1/04; C25B 15/08; F25J 1/00; H02K 7/18

(52) U.S. Cl. CPC C25B 9/65; C25B 1/04; C25B 15/08; F25J 1/001; H02K 7/1823

(57) ABSTRACT

In accordance with one aspect of the present disclosure, a method for generating hydrogen is provided. The method includes producing AC electric current from a hydroelectric turbine deployed under water at an offshore site. The method also includes converting the AC electric current into DC electric current and applying the DC electric current to an electrolyzer positioned above water at the offshore site of the hydroelectric turbine. The method further includes generating hydrogen via the electrolyzer.

### CROSS-REFERENCE TO RELATED APPLICATIONS

This application claims priority to U.S. Provisional Patent Application No. 63/238,538, filed Aug. 30, 2021, and entitled “Devices, Systems, and Methods for Hydrogen Generation, Collection, and Distribution,” the entire content of which is incorporated by reference herein.

### TECHNICAL FIELD

The present disclosure relates generally to systems and methods for hydrogen generation, collection, and distribution useful for producing electricity as an end product. More specifically, the present disclosure relates to the deployment of hydroelectric energy systems using various aquatic technologies to achieve a robust system for generating, collecting, and distributing hydrogen.

### INTRODUCTION

The section headings used herein are for organizational purposes only and are not to be construed as limiting the subject matter described in any way.

Utilizing renewable energy sources and decreasing the reliance on carbon-based energy production is of increasing interest throughout the world today. A variety of energy production technologies have been developed in an effort to reduce reliance on fossil fuels, including but not limited to, for example, electricity generation converted from fluid flow, such as wind or water currents. Such energy conversion systems often rely on a turbine in which blades interact with fluid currents (e.g., from wind or water) causing rotation of a rotor that spins a generator to produce electricity.

In a hydroelectric energy system, a hydroelectric turbine is used to generate electricity from the current in a moving body of water (e.g., a river, ocean, or other source of current) or other fluid source. Tidal power, for example, exploits the movement of water caused by tidal currents, or the rise and fall in sea levels due to tides. As the waters rise and then fall, a flow, or fluid current, is generated. The one-directional flow, for example, from a river also creates a current that may be used to generate electricity.

Aside from the production of electricity for distribution to a power grid, renewable energy sources, including but not limited to, fluid flow energy conversion systems, can be used to produce hydrogen by using the electricity produced by those systems to power electrolysis equipment (electrolyzers). The hydrogen generated by the electrolysis process can be stored and used as a non-carbon based form of fuel. Electrolysis is widely considered an efficient method of producing hydrogen. For example, using the technology that is currently available, electrolysis has been found to produce hydrogen at about 75 percent efficiency. So, to produce a kilo of pure hydrogen fuel, which holds about 39.4 kWh of energy, it would take about 52.5 kWh of electricity. By improving electrolysis efficiency to about 95 percent, it would only take about 41.5 kWh of electricity to generate a kilo of hydrogen fuel. To increase electrolysis efficiency, embodiments of the present disclosure contemplate, for example, utilizing high temperature electrolyzers.

Because of its reliance on and co-location with large bodies of water, hydroelectric energy systems may be particularly well-suited to the production of hydrogen using electrolysis. But various challenges exist in implementing such technology to achieve cost-effective, robust, and reliable hydrogen generation, collection, and distribution. For example, deployment of hydroelectric energy systems in water environments generally, and in ones that may be relatively remotely located from shore, pose challenges including but not limited to, protection of equipment from harsh environmental conditions, access to the sites of interest to deploy the systems, collection of the hydrogen from the sites, and/or distribution of the hydrogen to provide it to locations that may be too remote from the site of collection to distribute it directly.

Therefore, a need exists to develop devices, systems, and methods that address the above-mentioned challenges and enable hydrogen generation, collection, and distribution using renewable energy sources, such as hydroelectric energy systems, that are cost-efficient, robust, and reliable, and that can achieve a relatively low levelized cost of electricity.

### SUMMARY

Exemplary embodiments of the present disclosure may demonstrate one or more of the above-mentioned desirable features. Other features and/or advantages may become apparent from the description that follows.

Additional objects and advantages will be set forth in part in the description which follows, and in part will be obvious from the description, or may be learned by practice of the present teachings. At least some of the objects and advantages of the present disclosure may be realized and attained by means of the elements and combinations particularly pointed out in the appended claims.

In accordance with one aspect of the present disclosure, a method for generating hydrogen is provided. The method includes producing AC electric current from a hydroelectric turbine deployed under water at an offshore site. The method also includes converting the AC electric current into DC electric current and applying the DC electric current to an electrolyzer positioned above water at the offshore site of the hydroelectric turbine. The method further includes generating hydrogen via the electrolyzer.

In accordance with another aspect of the present disclosure, a system for generating, collecting, and distributing hydrogen from an offshore site is provided. The system includes a platform configured to be deployed at an offshore site in a body of water and to support equipment above the water at the offshore site. The system also includes an electrolyzer supported by the platform. The system further includes one or more autonomous surface energy collection vessels configured to couple to the platform via a cable configured to transmit electrical energy. Each of the one more autonomous surface energy collection vessels includes an electrical energy generation system configured to generate electrical energy for transmission to the electrolyzer via the cable, wherein the electrolyzer is configured to generate hydrogen gas from the electrical energy.

In accordance with yet another aspect of the present disclosure, a system for autonomously coupling a marine vessel to an anchored structure is provided. The system includes a first coupling device mounted on the marine vessel. The first coupling device includes a first portion of an interlock system. The system also includes a second coupling device mounted on the anchored structure. The second coupling device includes a second portion of the interlock system. The second portion of the interlock system is configured to engage with the first portion of the interlock system to secure the marine vessel to the anchored structure without any human intervention.

In accordance with a further aspect of the present disclosure a method of autonomously coupling a marine vessel to an anchored structure is provided. The method includes autonomously navigating the marine vessel to the anchored structure. The method also includes linking a first coupling device on the marine vessel with a second coupling device on the anchored structure. The method also includes exchanging position data between the first and second coupling devices. The method further includes engaging a first portion of an interlock system on the first coupling device with a second portion of an interlock system on the second coupling device to secure the marine vessel to the anchored structure without any human intervention.

It is to be understood that both the foregoing general description and the following detailed description are exemplary and explanatory only and are not restrictive of the present disclosure and claims, including equivalents. It should be understood the present disclosure and claims, in their broadest sense, could be practiced without having one or more features of these exemplary aspects and embodiments. For example, those of ordinary skill in the art would understand that the following detailed description related to the generation, collection, and distribution of hydrogen are exemplary only, and that the disclosed devices, systems, and methods can have various components, which utilize various semi-submersible platforms, hydroelectric energy systems, autonomous surface energy collection vessels (ASECVs), watercraft (e.g., tankers), and land vehicles, to generate, collect and distribute hydrogen to be used as a renewable energy source.

### BRIEF DESCRIPTION OF THE DRAWINGS

The accompanying drawings, which are incorporated in and constitute a part of this specification, illustrate various non-limiting embodiments of the present disclosure and together with the description, serve to explain certain principles. In the drawings:

FIG. 1 is a schematic flow diagram illustrating elements of a system and method of hydrogen production, collection, and distribution in accordance with the present disclosure;

FIG. 2A is a top view of a semi-submersible platform for oil drilling prior to retrofitting in accordance with an embodiment of the present disclosure;

FIG. 2B is a side view of the semi-submersible platform of FIG. 2A;

FIG. 3A is a top view of the semi-submersible platform of FIG. 2A, after refitting in accordance with an embodiment of the present disclosure;

FIG. 3B is a side view of the semi-submersible platform of FIG. 3A;

FIG. 4 is a side view of the semi-submersible platform of FIG. 3A with an anchoring device in accordance with an embodiment of the present disclosure;

FIG. 5 is a top view of the semi-submersible platform of FIG. 3A with multiple chains of autonomous surface energy collection vessels coupled to the semi-submersible platform in accordance with an embodiment of the present disclosure;

FIG. 6 is a front view of an autonomous surface energy collection vessel (ASECV) in accordance with an embodiment of the present disclosure;

FIG. 7 is a left side view of the ASECV of FIG. 6;

FIG. 8 is a right side view of the ASECV of FIG. 6;

FIG. 9 is a top view of the ASECV of FIG. 6;

FIG. 10 is left side view of the ASECV of FIG. 6 with a hydroelectric turbine lifted out of the water, in a raised position, via a turbine support structure in accordance with an embodiment of the present disclosure;

FIG. 11 is a side view of an autonomous surface vessel (ASV), including modular units and coupling bars, in accordance with another embodiment of the present disclosure;

FIG. 12 is a top view of the ASV of FIG. 11;

FIG. 13 is a schematic illustration of the modular units on the ASV of FIG. 11;

FIG. 14 is a perspective view of an exemplary embodiment of a modular unit in accordance with an embodiment of the present disclosure;

FIG. 15A is a schematic illustration of the ASV of FIG. 11 with an exemplary self-propulsion system utilized by the platform;

FIG. 15B is an enlarged, schematic view of a self-propulsion pod of the self-propulsion system of FIG. 15A;

FIG. 16 is schematic side view of the ASV of FIG. 11 coupled to an autonomous coupling buoy (ACB) in accordance with an embodiment of the present disclosure;

FIG. 17 is a top view of the ASV coupled to the ACB of FIG. 16 with the coupling bars in an undeployed configuration;

FIG. 18 is a top view of the ASV coupled to the ACB of FIG. 16 with the coupling bars in a partially deployed configuration;

FIG. 19 is a top view of the ASV coupled to the ACB of FIG. 16 with the coupling bars in a deployed configuration;

FIG. 20 is a top view of the ASV coupled to the ACB of FIG. 16, with the coupling bars in the deployed configuration and with multiple ASECVs coupled to the coupling bars in accordance with an embodiment of the present disclosure;

FIG. 21 is a top view of an autonomous coupling system in accordance with an embodiment of the present disclosure, illustrating an autonomous coupling buoy coupling to an autonomous barge;

FIG. 22 is a side view of the autonomous coupling system of FIG. 21; and

FIG. 23 is schematic side view of the ASV of FIG. 11 coupled to a pipeline for transport of hydrogen gas to an onshore location in accordance with an embodiment of the present disclosure.

### DETAILED DESCRIPTION

Production of energy using hydroelectric systems, such as underwater turbines, can pose challenges as power generation facilities are located further offshore. Such challenges may include the use of relatively complicated mooring systems to deploy the turbines, and lengthy cabling required to transmit the power from the source of generation to an onshore location. In an effort to address such challenges, while providing energy production alternatives to fossil fuel based technologies, methods and systems according to embodiments of the present disclosure utilize underwater turbines to generate electricity that is used to run electrolyzers co-located at a site where the underwater turbine is deployed in order to generate hydrogen, which in turn can be transported on shore in a relatively efficient and economical manner for use in downstream energy production.

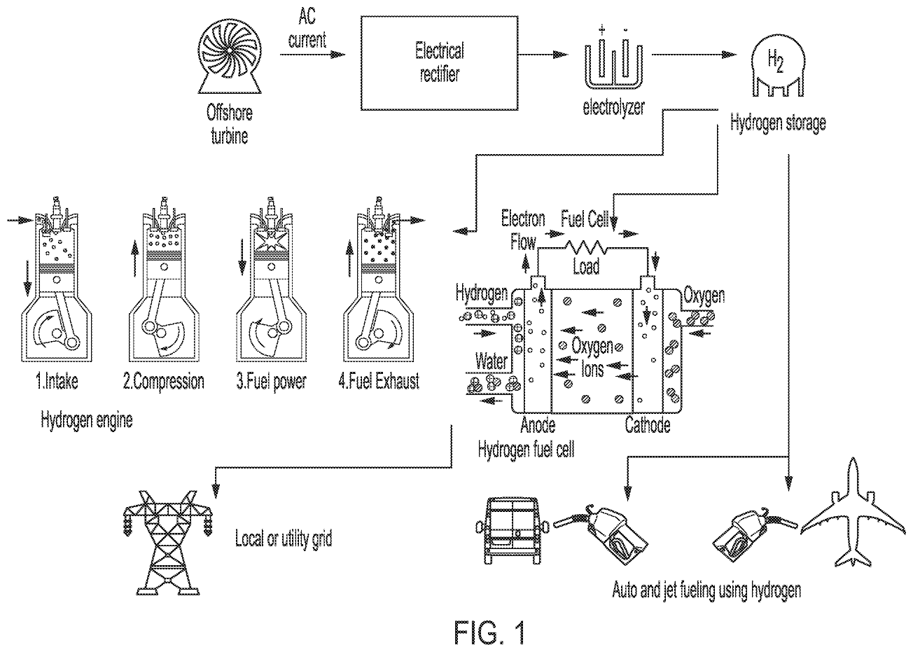

With reference to FIG. 1, a schematic flow diagram of one embodiment of a system and method for generating electricity via one or more hydroelectric turbines and converting the generated electrical power into a hydrogen fuel source (i.e., generating a form of hydrogen from the electricity). In the flow diagram, one or more offshore turbines (one being depicted in the schematic of FIG. 1), such as an underwater hydroelectric turbine, are deployed and used to generate AC (alternating current) electricity via a generator of the turbine. Those having ordinary skill in the art would appreciate that a variety of hydroelectric turbines could be used. Nonlimiting embodiments of hydroelectric turbines that could be used in the system and method of FIG. 1 are disclosed in U.S. Pat. No. 7,453,166 B2, entitled “System for Generating Electricity from Fluid Currents;” U.S. Pat. No. 9,359,991 B2, entitled “Energy Conversion Systems and Methods;” U.S. Pat. No. 10,389,209 B2, entitled “Hydroelectric Turbines, Anchoring Structures, and Related Methods of Assembly,” U.S. Pat. No. 10,544,775 B2, entitled “Hydroelectric Energy Systems, and Related Components and Methods;” U.S. Patent Application Publication No. 2021/0190032 A1, entitled “Hydroelectric Energy Systems and Methods; and “International Patent Application Publication No. WO/2020/118151, entitled “Orbital Magnetic Gears and Related Systems,” which are incorporated by reference herein. As would be understood by those of ordinary skill in the art, through a process known as electrolysis, the system and method illustrated in FIG. 1 can use an electrolyzer, powered by the electric current generated by the hydroelectric turbine(s), to split bonds between the hydrogen and oxygen atoms of water, thereby releasing hydrogen and oxygen gas. In various embodiments, by locating the electrolyzer at the site of the hydroelectric turbines, the loss of energy is relatively minimal, particularly as compared to transmitting electricity via transmission cables to more remote onshore locations. Because the electric current for the process of electrolysis is generated through renewable energy sources, the entire process can occur without release of additional carbon into the atmosphere, with the hydrogen that is produced via the electrolysis process being considered a zero-emission fuel source.

Like carbon-based energy sources such as fossil fuels, hydrogen is a form of energy that can be relatively easily stored and transported, particularly when in its liquid state. As illustrated in FIG. 1, the system and method further includes collecting and storing hydrogen (e.g., liquid hydrogen) produced from the electrolyzer, for example, in storage tanks, where it can be transported from the offshore hydrogen generation facility via, for example, cryogenic tankers, to onshore facilities where it is distributed as a fuel source. The generated hydrogen fuel can be used, for example, in hydrogen engines and/or fuel cells, which can in turn be integrated into local utility grids (e.g., to heat and light homes), used directly as an automotive or jet fuel source, or as any other fuel source as those of ordinary skill in the art would be familiar with.

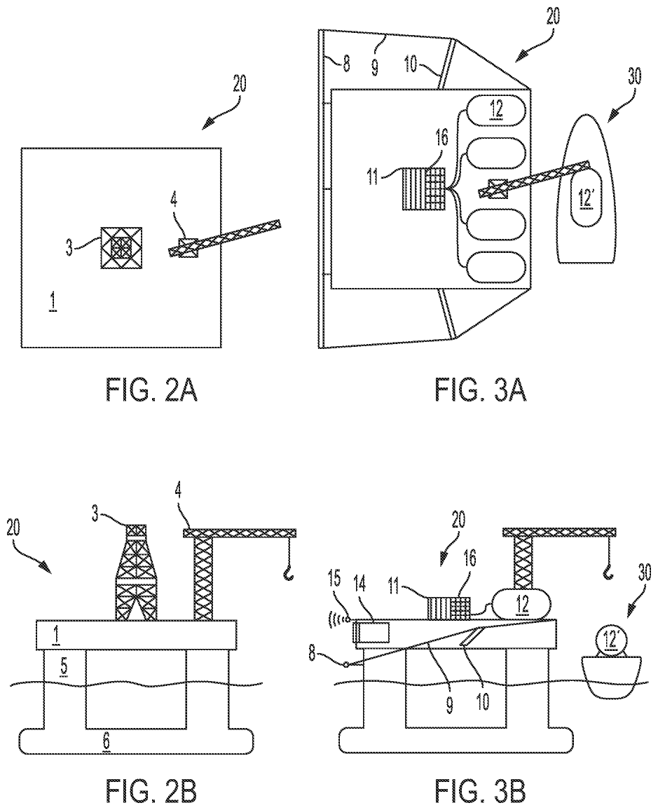

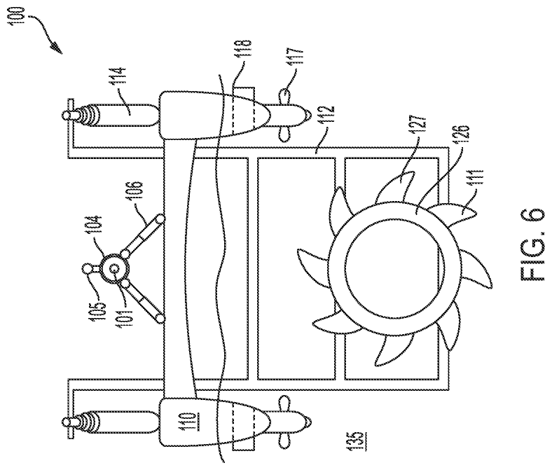

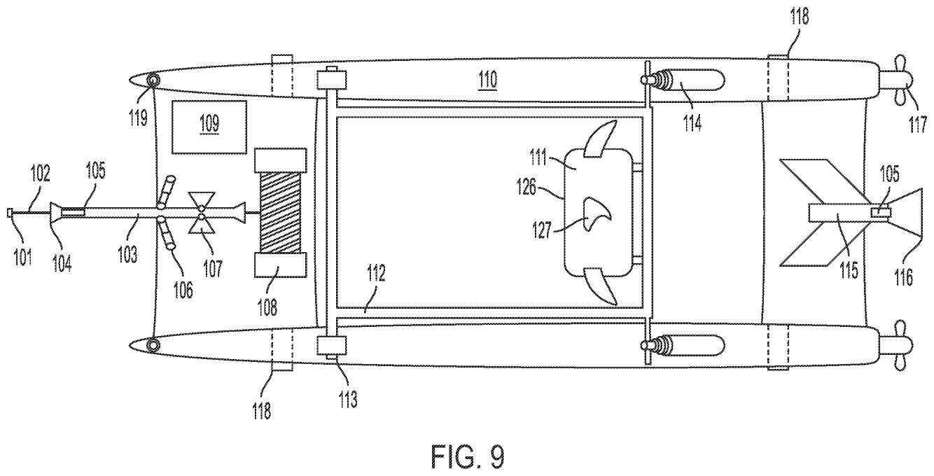

To efficiently enable hydrogen generation, collection, and distribution using renewable energy sources, such as hydroelectric turbines that are positioned offshore, the systems and methods of the present disclosure contemplate utilizing autonomous surface energy collection vessels (ASECVs) to deploy the hydroelectric turbines (see, e.g., FIGS. 6-10) and generation platforms, such as, for example, repurposed semi-submersible platforms (see, e.g., FIGS. 2-5) and/or moored autonomous surface vessels (see, e.g., FIGS. 11-22), to serve as offshore hydrogen generation facilities, each of which are described in further detail below.

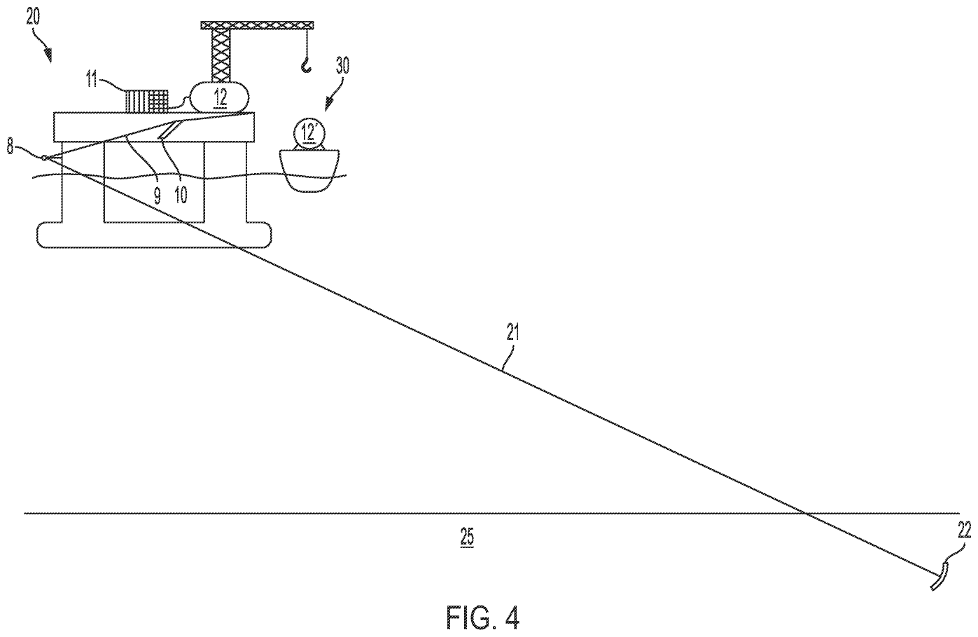

In accordance with one embodiment, as illustrated in FIGS. 2A-4, though any of a variety of semi-submersible platforms may be used, it may be beneficial and of lower cost to utilize a semi-submersible platform 20 conventionally used in the oil drilling industry that is repurposed and refitted to include an electrolysis plant (electrolyzer 11), a cryogenic liquefaction system 16 (i.e., to liquefy the hydrogen gas produced by the electrolyzer 11), and liquid hydrogen storage tanks 12. As illustrated in the views of the refitted semi-submersible platform 20 in FIGS. 3A and 3B, the semi-submersible platform 20 is further configured to transfer liquid hydrogen from the storage tanks 12 on the semi-submersible platform 20 to a liquid hydrogen storage tank 12′ on a tanker 30 for transport of the liquid hydrogen away from the semi-submersible platform 20 (e.g., to shore). As illustrated in FIG. 4, the semi-submersible platform 20 may be anchored anywhere offshore, such as, for example, via an anchor 22 that is imbedded in a sea bottom 25 and connected to the semi-submersible platform 20 via an anchor line 21. In this manner, the semi-submersible platform 20 may be towed out (e.g., via a powered marine vessel) and installed at a selected offshore site with minimal impact to the surrounding environment and may also be easily relocated to a new location if desired.

Those of ordinary skill would understand that the semi-submersible platform 20 illustrated in FIGS. 2A-4 is exemplary only and that the semi-submersible platforms contemplated by the present systems and methods may have various configurations and components without departing from the scope of the present disclosure and claims. The semi-submersible platforms contemplated by the present systems and methods may also utilize various techniques and methods to install the semi-submersible platform 20 at a selected offshore site, including but not limited to, the disclosed anchoring system. Those of ordinary skill in the art would further understand that the liquid hydrogen generated and stored on the semi-submersible platform 20 may also be transferred off the semi-submersible platform (e.g., back to shore) via any transport vehicle, system, and/or method known in the art. Various additional embodiments of the present disclosure also contemplate transporting the generated hydrogen back to shore directly in its gas form. In such embodiments, the semi-submersible platform 20 may forgo the installation of the cryogenic plant 16.

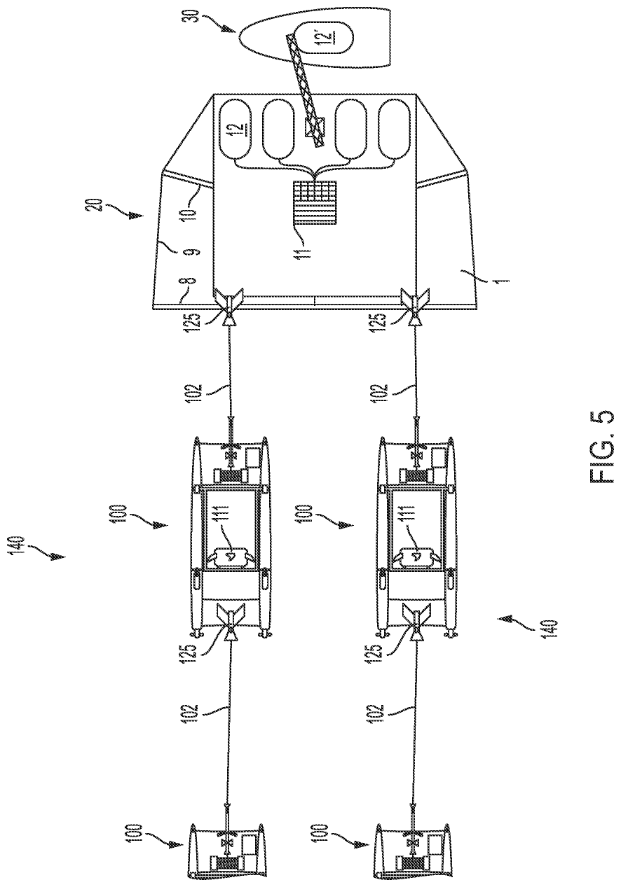

As illustrated in FIG. 5, in accordance with various embodiments of the present disclosure, a single moored semi-submersible platform 20 may be used to tether one or more serial chains 140 of autonomous surface energy collection vessels (ASECVs) 100 that continuously generate DC electrical power and transmit this power to the semi-submersible platform 20 through power/mooring cables 102. Each serial chain 140 of ASECVs 100 comprises one or more individual ASECVs 100, which are tethered together via a power/mooring cable 102 and a coupler 125. As illustrated in FIG. 5, in accordance with various embodiments, the cable 102 from one ASECV 100 may engage with the coupler 125 of another ASECV to tether the two ASECVs 100 together. In a similar manner, each chain 140 of ASECVs may tether to a deck 1 of the semi-submersible platform 20 via couplers 125 on the deck 1 of the semi-submersible platform 20. Various embodiments contemplate utilizing wet-mate connectors, as those having ordinary skill in the art would be familiar with, to tether two ASECVs together and/or couple a chain of ASECVs to the semi-submersible platform 20, as described further below.

Each ASECV 100, for example, can be configured to carry and deploy a hydroelectric turbine 111 that is configured to generate electricity from the current in the body of water in which the semi-submersible platform 20 is installed (e.g., an ocean current or other current from a body of water). In accordance with various embodiments, such hydroelectric turbines may comprise a stationary member (e.g., a stator) and a rotating member (e.g., a rotor) that is disposed radially outward of an outer circumferential surface of the stator (e.g., is concentrically disposed around the stator) and configured to rotate around the stator about an axis of rotation. Such turbines may, for example, have a plurality of blade portions extending both radially inward and radially outward with respect to the rotor. In this manner, the turbines must be positioned in a fluid body, such that a fluid flow having a directional component flow generally parallel to the axis of rotation of the rotor may act on the blade portions to cause the rotor to rotate about the axis of rotation. Nonlimiting embodiments hydroelectric turbines that may be used are described, for example, in U.S. Pat. No. 7,453,166 B2, entitled “System for Generating Electricity from Fluid Currents;” U.S. Pat. No. 9,359,991 B2, entitled “Energy Conversion Systems and Methods;” U.S. Pat. No. 10,389,209 B2, entitled “Hydroelectric Turbines, Anchoring Structures, and Related Methods of Assembly,” U.S. Pat. No. 10,544,775 B2, entitled “Hydroelectric Energy Systems, and Related Components and Methods;” U.S. Patent Application No. 2021-0190032 A1, entitled “Hydroelectric Energy Systems and Methods;” and International Patent Application Publication No. WO/2020/118151, entitled “Orbital Magnetic Gears and Related Systems,” the contents each of which is incorporated by reference in its entirety herein.

As described above, the hydroelectric turbines 111 supported by the ASECVs 100 are used to continuously cause the generation of DC (direct current) electrical power and transmit this power to the semi-submersible platform 20 via the power/mooring cables 102, where the DC electrical power is used by the electrolyzer to generate hydrogen gas. In various embodiments, for example, AC current is directly generated by the hydroelectric turbine 111 (e.g., via spinning of a generator as those of ordinary skill in the art would be familiar with). The AC electrical current may then be run through a rectifier (not illustrated) to convert the AC current into the DC electrical current that is supplied to the electrolyzer. In this manner, a rectifier (not shown) may also be located on each ASECV 100 to convert the AC electrical current that is generated internally in each turbine 111 to DC electrical current prior to transmitting the current via the power/mooring cables 102 and into the electrolyzer 11. The hydrogen gas produced by the electrolyzer is then cryogenically cooled to a liquid state via the cryogenic liquefaction system 16 and stored in the liquid hydrogen storage tanks 12, until it is transported to shore via marine vessels such as tankers 30, which may dock to the semi-submersible platform 20, for distribution.

The above-referenced embodiments of hydroelectric energy systems and their associated components are non-limiting, and the present systems and methods can be used with various types and configurations of hydroelectric energy systems. Furthermore, the present disclosure contemplates utilizing the disclosed systems and methods for generating, collecting, and distributing hydrogen utilizing DC current generated via various renewable energy sources, including but not limited to hydroelectric, wind, and solar energy sources, and is not intended to be limited to the exemplary hydroelectric turbines discussed in detail herein. Any such renewable energy generation systems may be deployed in a similar manner in lieu of a hydroelectric turbine at a semi-submersible platform via ASECVs.

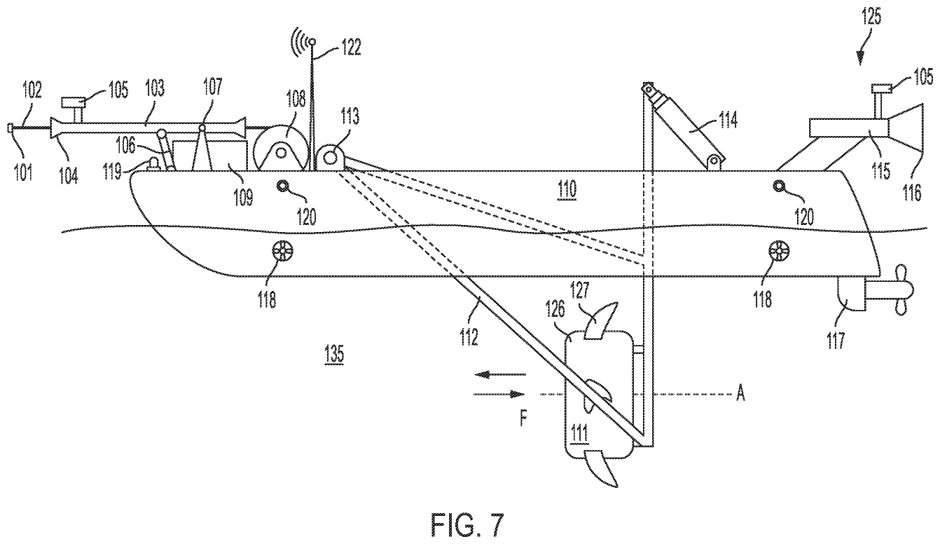

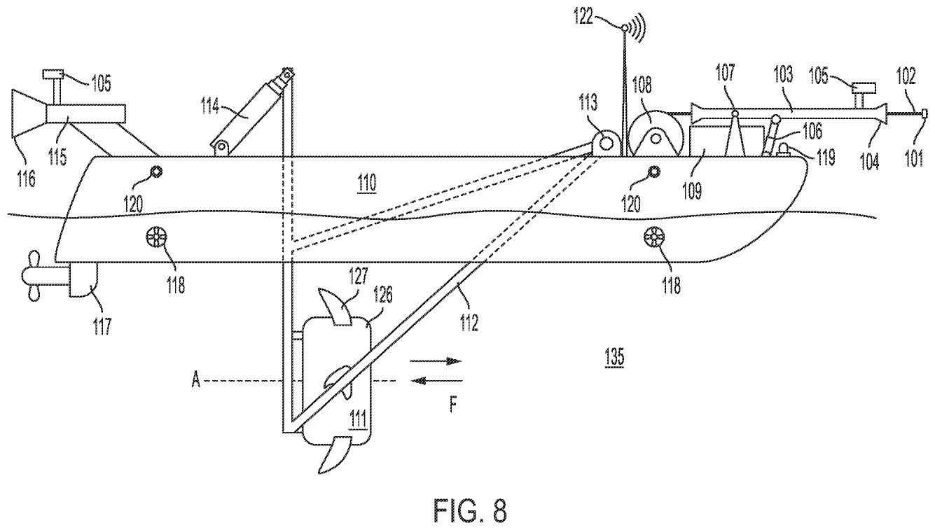

As illustrated in FIGS. 5-10, embodiments of the present disclosure contemplate utilizing one or more autonomous surface energy collection vessels (ASECVs) 100 to carry and deploy onboard hydroelectric turbines 111, such as those described above. Each ASECV 100 may include, for example, a hull 110 with a turbine support structure 112. In an embodiment, the hull 110 can be a catamaran hull, but other hull configurations are contemplated as within the scope of the present disclosure. In accordance with various embodiments, the turbine support structure 112 is configured to support the hydroelectric turbine 111 in a fluid body 135 in which the hull 110 floats, such that a fluid flow having a directional component flow F generally parallel to an axis of rotation A of a rotor 126 may act on blade portions 127 to cause the rotor 126 to rotate about the axis of rotation A (see FIGS. 7 and 8). It would be understood by those of ordinary skill in the art, however, that the turbines of the present disclosure may be configured to operate with various and changing directions of fluid flow and are configured to operate with both the ebb and flow of, for example, tidal currents, as well as currents coming from only one direction, such as, for example, river currents.

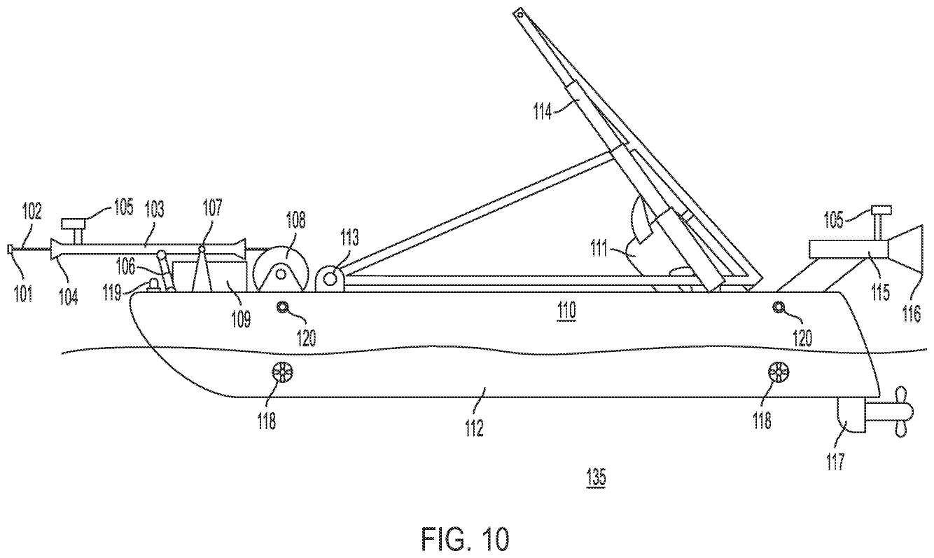

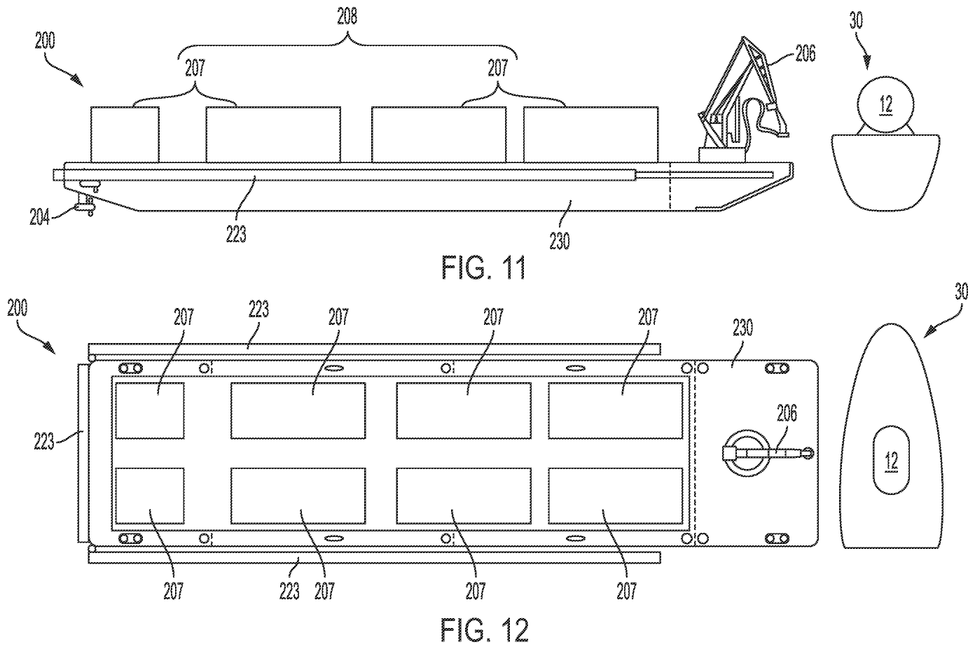

In accordance with an embodiment, the turbine support structure 112 is further configured to raise and lower the hydroelectric turbine 111 between a first, deployed position in which the turbine 111 is positioned below the hull 110 and in the fluid flow to collect energy (see FIGS. 6-9), and a second, stowed position in which the hydroelectric turbine 111 is raised out of the fluid (i.e., above the water line) so as to allow for autonomous maneuvering of the ASECV 100 (see FIG. 10).

In accordance with various embodiments, each ASECV 100 is configured to autonomously navigate to and from the semi-submersible platform 20, to couple and uncouple from the semi-submersible platform 20, and to tether and untether from its respective serial chain 140. In this manner, any ASECV 100 may untether from the chain 140 and autonomously navigate to a pre-determined location for maintenance while the remaining ASECVs 100 and any replacement ASECVs autonomously retether together as needed. Furthermore, to prevent damage to the ASECVs 100 and their payloads (e.g., hydroelectric turbines 111), all the ASECVs 100 can also untether in sequence from each serial chain 140 and autonomously navigate to a pre-determined safe location away from the predicated path of a storm or other event that may cause damage. The ASECVs 100 may then retether in sequence to reform each serial chain 140 once the threat of the event has passed.

In accordance with various embodiments, systems and methods of the present disclosure may utilize an ASECV 100 that includes onboard sensors 119 and 120 and a control system (housed in control room 109) to autonomously couple/uncouple to the semi-submersible platform 20 and to tether/untether to another ASECV 100 (i.e., in a serial chain 140). For automated coupling/tethering, the ASECV 100 may, for example, approach a cable receptacle 115 of the coupler 125 (either on the semi-submersible platform 20 or another ASECV 100). Onboard video camera images, such as via a video camera 105 on the coupler 125, may be used to provide control signals to linear actuators 106 and a thrust vectoring propulsion system (e.g., propeller 117 and side thrusters 118). The linear actuators 106 can be mounted at 90 degrees to each other and placed at an angle for convenient mounting to a hull, such as a catamaran hull, rather than vertical/horizontal, with the front of an articulated cable strut 103 being dynamically positioned within a radius set by the strut 103 and actuator 106 geometry to assist in coupling/tethering. Once coupled/tethered, a wet mate connector 101 may provide electrical power, data, and mechanical connection for the power/mooring cable 102, which can then be paid out to the desired separation distance using a winch/reel system 108. In a similar manner, when an ASECV 100 is tethering to another ASECV 100, the “receiving” ASECV 100 may use the video camera 105 and thrust vectoring propulsion system to assist in alignment during tethering, at least in a horizontal axis.

When uncoupling/untethering, the wet mate connector 101 is mechanically released and the winch/reel system 108 pulls the cable 102 into the strut 103, so that the ASECV 100 is ready for autonomous maneuvering, navigation, and eventual recoupling/tethering.

Those of ordinary skill in the art would understand that the ASECV 100 illustrated and described with reference to FIGS. 6-10 is exemplary only and that ASECVs in accordance with the present disclosure may have various configurations and various components, having various compliances and tolerances, to support a hydroelectric turbine 111 and to couple/tether and uncouple/untether to/from the semi-submersible platform 20 and to/from each other. In various embodiments, for example, the actuators 106 have some built-in compliance (e.g., the actuators 106 are sprung and lightly damped) to minimize radial shock loads when coupling/tethering in waves, and can retain that compliance while moored, to minimize dynamic cable loads on the ASECV 100 due to wind and sea state. Likewise, the “fixed” cable receptacle 115 may have some axial compliance to minimize coupling/tethering loads, and the winch 108 may also pay out to minimize cable loads due to wind and sea state if necessary.

As would be understood by those of ordinary skill in the art, each ASECV 100 may be programmed (e.g., with global positioning system (GPS) coordinates) to automatically travel between designated locations. The autonomous nature of the ASECV may allow the vessel to move between the semi-submersible platform 20 and designated various secondary locations, including, for example, the shore, additional energy collection locations, maintenance locations, and/or safe harbor locations, while allowing the operation to be controlled and monitored from shore, from the semi-submersible platform 20, or from any other offshore location, such that a human operator is not required for operation of the ASECV. In various embodiments, a data link transmission between a controller 109 housed on the ASECV 100 and a controller 14 housed on the semi-submersible platform 20 may occur by means of high frequency radio signals broadcast between a transmitter 122 on the ASECV 100 and an antenna 15 on the semi-submersible platform 20. This may additionally help with the safety of the deployment and with the ease of maintenance, as a deployment crew is not required to physically be at the deployment location of any of the hydroelectric turbines 111 or make trips out to the deployment location for maintenance purposes.

The ASECVs in accordance with various embodiments of the present disclosure may include various types and arrangements of autonomous vessel components, employ various types and configurations of autonomous control and monitoring units, and utilize various systems and methods to link the autonomous vessels to, for example, a control room. Those of ordinary skill in the art would further understand that, although the above exemplary ASECV utilizes GPS coordinates for its autonomous operations, the systems and methods of the present disclosure contemplate using any known methods to autonomously guide the vessels back and forth between desired locations.

Moreover, in various embodiments, remotely controlled operation of ASECVs is contemplated, such that rather than be programmed to automatically begin various operational tasks based on sensing location, etc., operators may utilize remote control input devices wirelessly communicating with the vessel to reposition the vessel and to transition the vessel to perform various tasks (e.g., to raise and lower the turbine support structure 113), akin to robotic control systems technologies. Such remote-controlled operation may be used in combination with more fully automated operation.

With reference now to FIGS. 11-22, various additional embodiments of the present disclosure also contemplate utilizing one or more autonomous surface vessels (ASVs) 200, in combination with or instead of a semi-submersible platform, to collect the DC electrical power generated by the ASECVs 100, to generate the hydrogen from the collected electrical power, and/or to store the hydrogen for later onshore transport. Such autonomous platforms may be advantageous to use, for example, in areas where a semi-submersible platform (such as an existing platform for retrofitting) is not available or practical and/or in areas susceptible to volatile weather or other conditions where having the ability to move equipment to a different location is desirable. In accordance with various embodiments, each ASV 200 is configured to autonomously navigate to and from an offshore site, where it may autonomously couple to an anchored structure, such as, for example, a moored surface buoy (e.g., an autonomous coupling buoying (ACB)) at the site, as described further below. In this manner, the ASV 200 may also autonomously uncouple from the buoy and navigate to a pre-determined location for maintenance and/or to avoid bad weather (e.g., to a pre-determined safe location away from the predicated path of a storm or other event that may cause damage to the vessel). The ASV 200 may then navigate back to and recouple with the buoy at the offshore site once the threat of the event has passed.

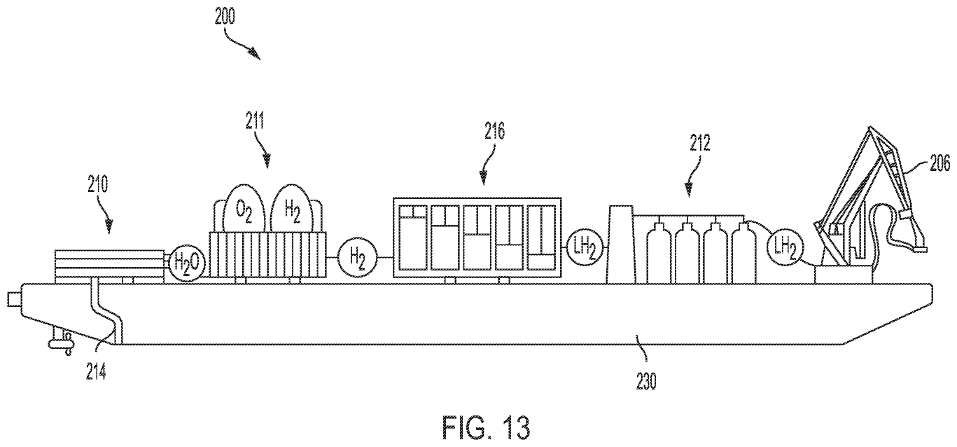

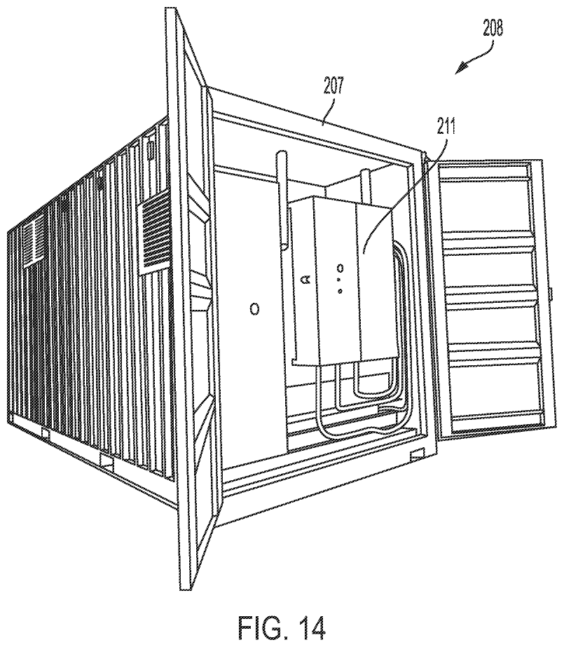

Although any of a variety of autonomous surface vessels may be used, as illustrated in FIGS. 11-13, it may be beneficial to utilize an autonomous barge 200 having a floating platform 230 that is fitted with a modular hydrogen production plant including individual modular units 208. As shown best perhaps in the schematic and enlarged views of FIGS. 13 and 14, the modular units may include containers 207 that respectively contain a water purification plant 210 (e.g., that is configured to draw in seawater via a pipe 214 and desalinate the seawater), an electrolysis plant (electrolyzer 211), a cryogenic plant 216 (i.e., to liquefy the hydrogen gas produced by the electrolyzer 211), and liquid hydrogen storage tanks 212. In this manner, the individual units 208 of the hydrogen production plant are self-contained and portable, such they can be easily replaced and swapped out for new units when needed. The modular nature of the units 208, therefore, facilitates the efficient maintenance of the hydrogen production plant. Those having ordinary skill in the art would appreciate that each container 207 need not store all of the components listed above and various such equipment can be distributed among different containers and/or be omitted depending on a particular application.

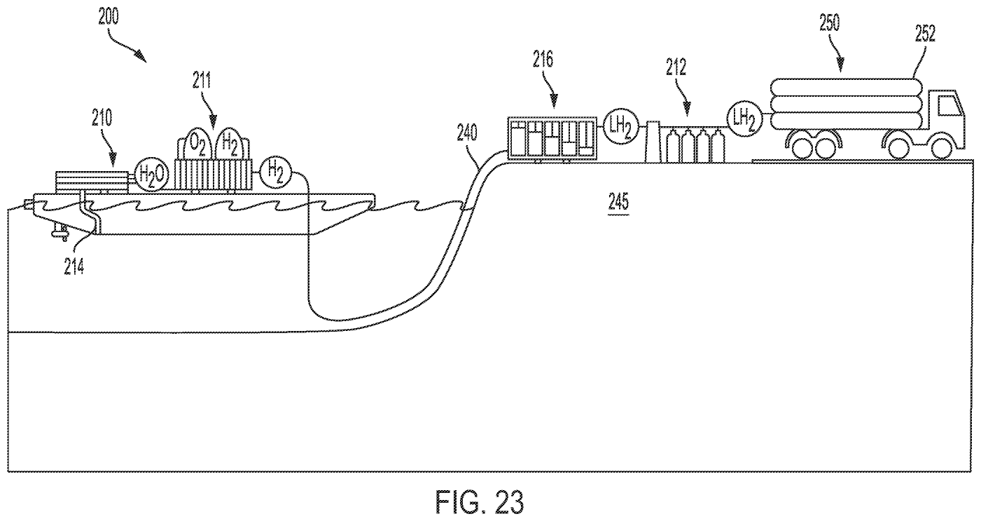

As illustrated in the views of the barge 200 in FIGS. 11 and 12, the autonomous barge 200 is further configured to transfer liquid hydrogen from the storage tanks 212 on the barge 200 to a liquid hydrogen storage tanker 30 via, for example, a transfer device 206, for transport of the liquid hydrogen away from the barge 200 (e.g., to shore). Alternatively, the autonomous nature of the barge 200 also allows the barge 200 to autonomously navigate to a storage tanker and/or other collection/storage facility (e.g., on shore) to transfer the liquid hydrogen from its storage tanks 212. Various additional embodiments of the present disclosure also contemplate transporting the generated hydrogen back to shore directly in its gas form. As illustrated in FIG. 23, the barge 200 may autonomously navigate to a location where the generated hydrogen gas can be transferred back to an onshore location 245 via, for example, a pipeline 240. In such embodiments, the barge 200 may forgo the installation of the modules carrying the cryogenic plant 216 and the liquid hydrogen storage tanks 212, and these modules may instead be located at the onshore location 245. In various embodiments, for example, the liquid hydrogen produced by the onshore cryogenic plant 216 and stored in the onshore storage tanks 212 may be transferred to storage tanks 252 on a tanker truck 250 for further transport. As would be understood by those of ordinary skill in the art, in such embodiments, other components of the hydrogen generation process could also be located at the onshore location 245. For example, in another embodiment, to also forgo installation of the module carrying the water purification plant 210 and the pipe 214 (to desalinize the seawater) on the barge 200, pure water my instead be pumped from the onshore location 245 to the electrolyzer 211 on the barge 200.

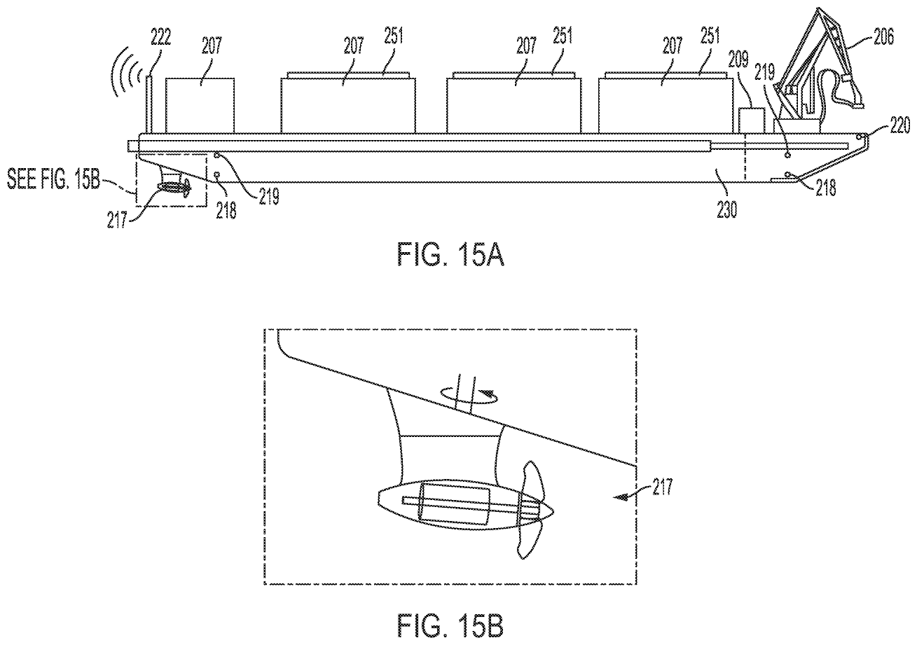

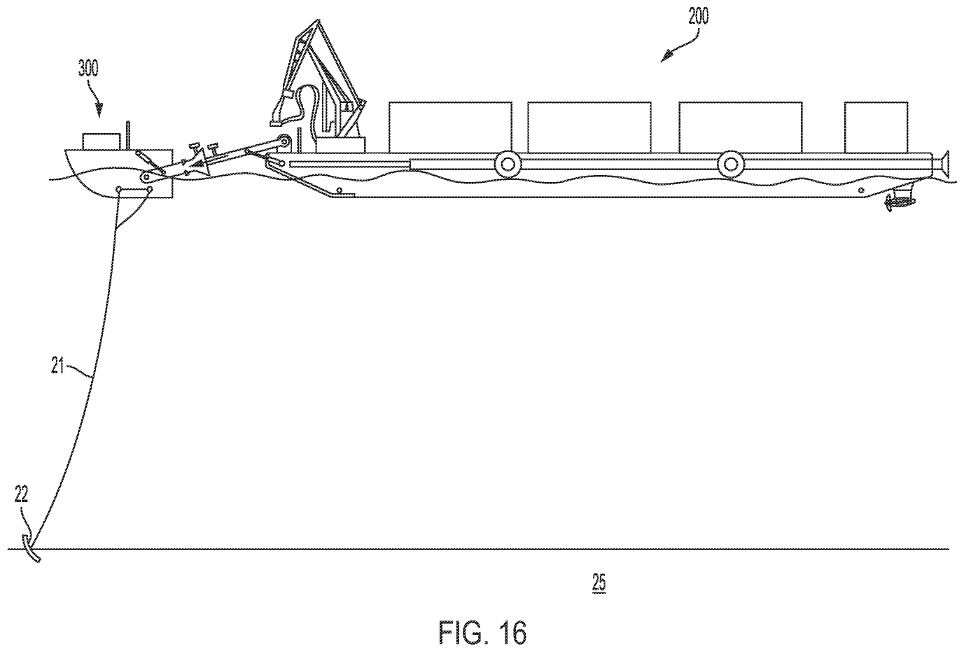

With reference to FIGS. 15A and 15B, which schematically depict the ASV 200 for ease of illustration of the autonomous components of the vessel, similar to the ASECVs 100 described above, the contemplated ASVs 200 may include onboard sensors 219 and 220 and a control system 209 housed on the ASV 200 to autonomously navigate to/from the offshore location and to couple/uncouple to an anchored structure 300 at the offshore location, as depicted in FIG. 16. The ASV may, for example, be programmed (e.g., with global positioning system (GPS) coordinates) to automatically travel between designated locations. The autonomous nature of the ASV 200, therefore, allows the vessel to move between the anchored structure 300 and various designated secondary locations, including, for example, additional anchored structures 300, the shore, maintenance locations, and/or safe harbor locations, while allowing the operation to be controlled and monitored from shore, or from another offshore location, such that a human operator is not required for operation of the ASV 200. In various embodiments, a data link transmission between the controller 209 on the ASV 200 and a controller in a control room at a control location (not shown) may occur by means of high frequency radio signals broadcast between a transceiver 222 on the ASV 200 and an antenna at the control location (not shown). The controller on the ASV 200 may also propel and reposition the ASV 200 via a self-propulsion system on the ASV 200, based on data received from the control location. In one embodiment, the self-propulsion system may include one or more podded propellers 217, each propeller 217 being powered by an electric motor (not shown), and one or more side thrusters 260. The electric motor may, for example, be powered by electricity supplied by batteries (not shown), which are charged by solar panels 251 mounted on top of the containers 207 on the ASV 200 or by a generator that runs on hydrogen, as would be understood by those of ordinary skill in the art.

Those of ordinary skill would understand that the ASVs 200 illustrated in FIGS. 11-15 are exemplary only and that the ASVs contemplated by the present systems and methods may have various configurations and components, including various configurations and types of hydrogen production components and various configurations and types of autonomous components, without departing from the scope of the present disclosure and claims.

As illustrated in FIG. 16, to install the ASV 200 at an offshore location, in accordance with various embodiments, the ASV 200 may be coupled to an anchored structure, such as, for example, a moored ocean surface buoy 300, that is tethered to an anchor 22 that is imbedded in a sea bottom 25 and connected to the ocean surface buoy 300 via an anchor line 21. As discussed further below, various embodiments of the present disclosure contemplate utilizing an autonomous coupling system (ACS) to autonomously couple the ASV 200 with an ocean surface buoy fitted as an autonomous coupling buoy (ACB) 300. The ASVs contemplated by the present systems and methods may, however, utilize any known techniques and methods to anchor the ASV 200 at a selected offshore site.

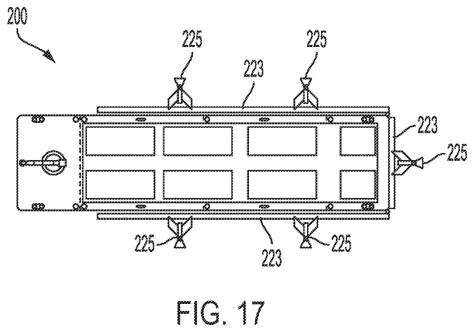

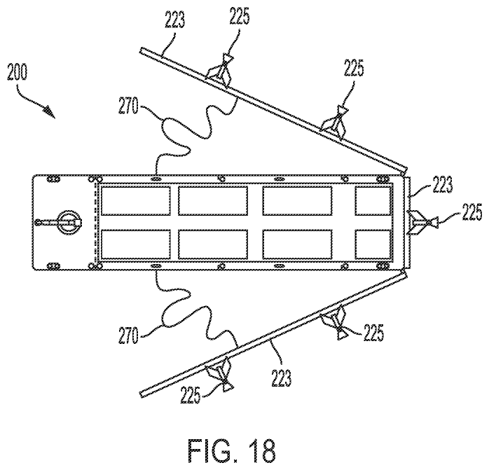

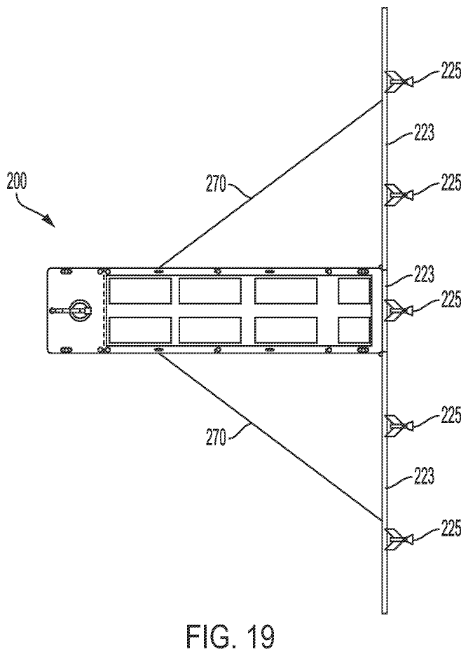

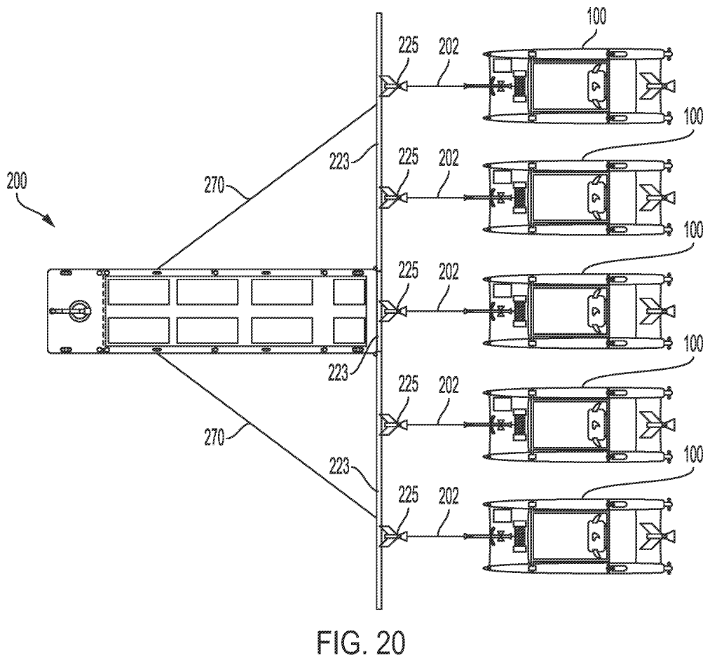

With reference now to FIGS. 17-20, once anchored at a designated offshore site, a single moored ASV 200 may be used to tether one or more autonomous surface energy collection vessels (ASECVs) 100 that continuously generate DC electrical power and transmit this power to the modular hydrogen production plant on the ASV 200 through power/mooring cables 202 (see FIG. 20). In one embodiment, similar to the semi-submersible platform 20 discussed above, the ASV 200 may include one or more couplers 225 that are configured to engage with the power/mooring cables 202 of the ASECVs 100. The ASV 200 may include, for example, a plurality of couplers 225 arranged along one or more coupling bars 223. As illustrated progressively in FIGS. 17-20, in various embodiments, the coupling bars 223 are deployable between an undeployed position in which the coupling bars 223 are folded against the sides of the ASV 200 (see FIG. 17) and a deployed position in which one or more of the coupling bars 223 are extended outward from the sides of the ASV 200 to form a linear docking structure for the ASECVs 100 (see FIG. 20). As shown in FIGS. 18 and 19, in one embodiment, cables 270 may run between the ASV 200 and the coupling bars 223, such that, upon full deployment of the coupling bars 223, the cables are in tension to help support the coupling bars 223. Although not shown, as discussed above with reference to FIG. 5, the ASECVs 100 may also be tethered to the ASV 200 in one or more serial chains of ASECVs 100 (i.e., each serial chain of ASECVs 100 comprising one or more individual ASECVs 100, which are tethered together via a power/mooring cable 202 and a coupler 225).

Those of ordinary skill in the art will understand that the ASVs 200 illustrated in FIGS. 17-20 are exemplary only and that the disclosed ASVs 200 may employ any known methods and/or techniques to couple with the ASECVs 100, including, but not limited to couplers 225 posited on deployable coupling bars 223. Furthermore, the contemplated ASVs 200 may utilize any number and configuration of coupling bars 223, having various numbers, types, and configurations of couplers 225, and are not intended to be limited to the embodiment shown. The present disclosure further contemplates, for example, employing an autonomous coupling system (ACS) to couple the ASECVs 100 to the ASV 200, as described further below.

Embodiments of the present disclosure further contemplate, for example, an autonomous coupling system (ACS) that enables an autonomous surface vessel (ASV) to autonomously couple and de-couple to another vessel, such as, for example, an anchored structure (e.g., moored ocean surface buoy), another ASV, and one or more ASECVs, without any human intervention. The contemplated ACS includes an autonomous coupling subsystem mounted on each of the vessels to be coupled together (e.g., the ASV and the anchored structure). The ACS may include, for example, a first coupling device mounted on the vessel and a second coupling device mounted on the anchored structure. In one embodiment, the first coupling device includes a first portion of an interlock system, and the second coupling device include a second portion of the interlock system, such that when connected the first and second portions of the interlock system lock together to secure the vessel to the anchored structure.

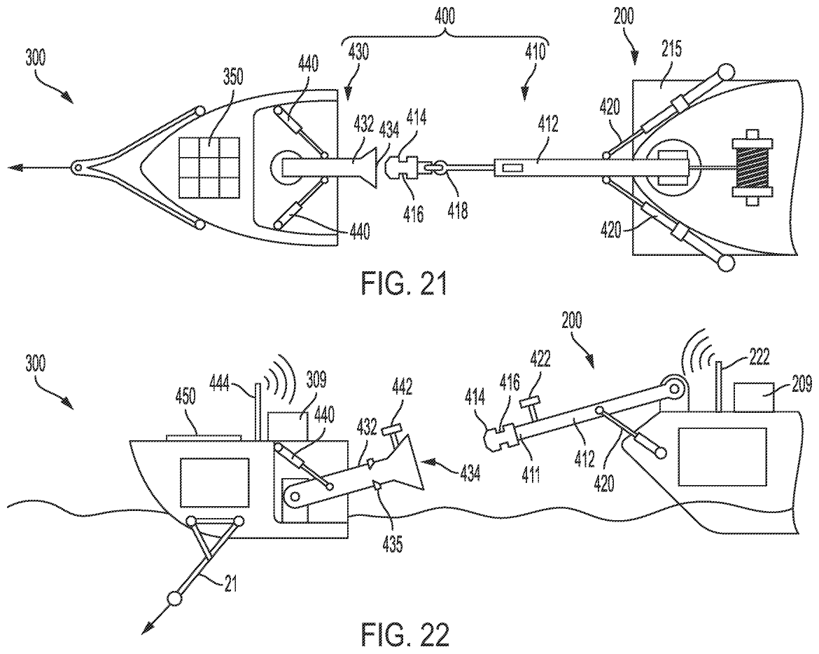

With reference to FIGS. 21 and 22, an ACS 400 for autonomously coupling an ASV 200 to an anchored structure, for example, a modified ocean surface buoy 300, is now described. Embodiments of the present disclosure contemplate, for example, modifying (or retrofitting) a preexisting buoy, such as, for example, an ocean surface buoy, as used by the National Data Buoy Center, to include an autonomous coupling subsystem of the ACS 400. Such buoys may include, for example, a Navy Oceanographic Meteorological Automatic Device (NOMAD), discus, or coastal buoy. The modified ocean surface buoy, with the autonomous coupling subsystem installed, will be referred to as an Autonomous Coupling Buoy (ACB). In various embodiments, an ACB may also utilize a wind vane and/or a water vane to align the ACB coupling device directly away from the prevailing wind direction and/or downstream from the water current direction to facilitate easier coupling in wind and/or water current conditions. The ASV 200 may have an analogous autonomous coupling subsystem installed, for example, in a forward end of the ASV 200 during initial construction or as a retrofit to an existing ASV. The ACS 400 refers to the combined installed autonomous coupling subsystems in both the buoy (ACB) and vessel (ASV).

As illustrated in FIGS. 21 and 22, the ACS 400 includes a first coupling device 410 mounted on the ASV 200 and a second coupling device 430 mounted on the ACB 300. The first coupling device 410 and second coupling device 430 are complementary so as to provide an engagement between the two. In one embodiment, the ACS comprises a mechanical interlock system 400, such that the first coupling device 410 includes a 2-axis articulated coupling strut 412 that is mounted at a forward end 215 of the ASV 200 and the second coupling device 430 includes a 2-axis articulated receptacle 432 mounted to the ACB 300. In one embodiment, the coupling strut 412 includes a plunger 414 at a forward end 411 of the strut 412, and the receptacle 432 includes a spring-loaded latching mechanism 434 that is configured to engage a slot 416 in the plunger 414 to lock the plunger 414 into the receptacle 432 at final coupling. In another embodiment, the plunger 414 is connected to a cable 418 that can be deployed through the coupling strut 412 to allow the ASV 200 to achieve a desired separation distance from the ACB, while remaining connected, to allow more relative motion and reduce connection stress between the ASV 200 and the ACB 300 in varying wind and wave conditions. A solenoid (not shown) connected to the latching mechanism 434 in the receptacle 432 can be commanded to retract the locking latches 435 for de-coupling, as would be understood by those of ordinary skill in the art.

The ACS 400 may also include mechanical actuators 420 and 440 on the ASV 200 and ACB 300, respectively, which are configured to provide dynamic and continuous control of the altitude and azimuth angles of the coupling strut 412 and the receptacle 432 to facilitate mutual alignment of the components during final coupling (e.g., in the presence of wind, waves and water surface currents). The mechanical actuators 420 and 440 can be electrically or hydraulically powered, as would be understood by those of ordinary skill in the art. In a simplified embodiment, the mechanical actuators 420 and 440 can be replaced by passive springs and hydraulic dampers, or flexible rubber mounts, which may also allow vertical and horizontal angular deflection of the components to facilitate mutual alignment during final coupling.

The ACS 400 may additionally include position sensors 422 and 442, which are respectively mounted at the forward end 411 of the coupling strut 412 on the ASV 200 and adjacent to the receptacle 432 on the ACB 300. The position sensors 422 and 442 are configured to continuously monitor a relative position of the receptacle 432 relative to the forward end 411 of the coupling strut 412 during the approach of the ASV 200 prior to final coupling to the ACB 300. The position sensors 422 and 442 on the ASV 200 and ACB 300 can include but are not limited to: GPS with Real-Time Kinematic processing (RTK), video cameras with 3D object recognition, plus infrared, ultrasonic, capacitive, inductive, photoelectric and/or LIDAR proximity sensors. In addition, dynamic motion sensors such as 3-axis accelerometers and gyroscopes may be utilized. In one embodiment, multiple position sensors may be utilized on both the ASV 200 and ACB 300 to improve coupling reliability through redundancy and cross-correlation.

Control system processors 209 and 309 housed on the ASV 200 and ACB 300, respectively, may, for example, utilize data from the position sensors 422 and 442 in conjunction with a control algorithm to provide speed and direction guidance to the ASV 200 during final approach, as well as provide directional control to the mechanical actuators 420 and 440 on both the ASV 200 and ACB 300 to facilitate continuous angular alignment of the coupling strut 412 and the receptacle 432 during final approach. In accordance with various embodiments, the control system processor on each of the ASV 200 and ACB 300 may have three basic operational modes: standby mode (default), coupling mode, and de-coupling mode, as described in more detail below.

In various embodiments, for example, each of the control system processors 209 and 309 includes a memory. The memory includes components configured to store and/or retrieve information. In some examples, the memory may be or include one or more storage elements such as Random Access Memory (RAM), Read-Only Memory (ROM), memory circuit, optical storage drives and/or disks, magnetic storage drives and/or tapes, hard disks, flash memory, removable storage media, and the like. The memory can store software which can be used in operation of the ACS 400 and implementation of the algorithms. Software can include computer programs, firmware, or some other form of machine-readable instructions, including an operating system, utilities, drivers, network interfaces, applications, and the like.

The processors 209 and 309 may include, for example, a microprocessor or other circuitry to control other elements of the ACS 400 and/or the respective ASV 200 and ACB 300 to process instructions retrieved from the storage element or other sources, to execute software instructions to perform various method operations (including but not limited to those described in the present disclosure, to apply signal processing and/or machine learning algorithms to analyze data, to perform calculations and/or predictions, and the like. In some examples, the processor may be or include one or more central processing units (CPUs), arithmetic logic units (ALUs), floating-point units (FPUs), or other microcontrollers.

Individual components of the ACS 400, ASV 200, and ACB 300 may be implemented via dedicated hardware components, by software components, by firmware, or by combinations thereof. Hardware components may include dedicated circuits such as application-specific integrated circuits (ASICs), field-programmable gate arrays (FPGAs), and the like. Software components may include software modules stored in memory, instructions stored on a non-transitory computer readable medium (e.g., internal memory or an external memory) and executed by a processor (e.g., a controller), remote instructions received from an external source (e.g., via a communication circuitry), and the like.

The exemplary devices, systems and methods described herein can be performed, for example, under the control of the processor executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices.

Radio transceivers, such as, for example, short-range radio transceivers, may also be utilized by the ACS 400. In one embodiment, the ACS 400 may utilize the transceiver 222 on the ASV 200 and a second transceiver 444 on the ACB 300. The transceivers 222 and 444 may each be configured to transfer position sensor data and command and control information from the control system processors to the mechanical actuators 420 and 430, once the ASV 200 is in close proximity to the ACB 300.

The existing onboard power systems on the ASV 200 may be utilized to provide power to the autonomous coupling subsystem on the ASV 200, while the ACB 300 may be outfitted with a power subsystem 350 to power its autonomous coupling subsystem. The power systems may power the mechanical actuators 420 and 430, the position sensors 422 and 442, the control system processors (i.e., located within the control box 209 and the control box 309), and transceivers 222 and 444. In various embodiments, the power subsystems may include, for example, power storage devices, such as, for example, batteries, solar panels and/or turbine generators, associated battery charge controllers, and any required power distribution controllers and wiring for the mechanical actuators 420 and 440, position sensors 422 and 442, control system processors, and transceivers 222 and 444. In one embodiment, the power storage devices may include a fuel such as hydrogen or diesel, with associated power conversion equipment. In another embodiment, the mechanical interlock system may be modified to allow power transfer between the ASV 200 and the ACB 300.

The ACS 400 described above can be implemented to autonomously dock the ASV 200 to the ACB 300 (e.g., which is anchored at an offshore location) using the following exemplary method. As the ASV 200 navigates to the offshore location of the ACB 300, the onboard autonomous navigation and control system of the ASV 200 may utilize the control system processor 209 and the radio transceiver 222, while the control system processor's coupling components are in a standby mode. When the ASV 200 is in close proximity to the offshore location (e.g., approximately 100 meters from the offshore location), such that the transceiver 222 on the ASV 200 is able to link with the transceiver 444 on the ACB 300, the control system processor on each of the ASV 200 and the ACB 300 goes into a coupling mode, which activates the respective components of each of the coupling devices 410 and 430 (e.g., the position sensors 422 and 442, the mechanical actuators 420 and 440, and the coupling strut 412 and the receptacle 432).

In this manner, as the ASV 200 approaches the ACB 300, the control system processors 209 and 309 may continuously receive signals from each of the position sensors 422 and 442 and may exchange position data between the first and second coupling devices 410 and 430 to monitor the approach of the ASV 200. In various embodiments, for example, the control system processors 209 and 309 are configured to continuously monitor an approach speed, a distance, and a direction of the approaching ASV 200 based on the signals from the position sensors 422 and 442.

Upon final approach, to facilitate a mutual alignment between the coupling strut 412 of the ASV 200 and the receptacle 432 of the ACB 300 during a final coupling of the components (e.g., in the presence of wind, waves and/or water surface currents), the control system processors 209 and 309 are also configured to continuously control an altitude angle and an azimuth angle of each of the coupling strut 412 and the receptacle 432. Thus, during the final coupling, the control system processors 209 and 309 work together to navigate the ASV 200 forward, adjusting the alignment between the coupling strut 412 and the receptacle 432 until the plunger 414 of the coupling strut 412 enters the receptacle 432, where it is locked into place by the spring-loaded latching mechanism 434. Once the ASV 200 and the ACB 300 are connected, the control system processors 209 and 309 revert to a standby mode.

To later disconnect from the ACB 300, the control system processor 209 on the ASV 200 enters a de-coupling mode by sending a command (e.g., over the radio transceiver 222) to the processor 309 of the ACB 300 to release the latching mechanism 434. In one embodiment, for example, an electrically actuated solenoid (not shown) on the receptacle 432 may release the latching mechanism 434 when it receives a control prompt from the processor 309. The ASV 200 may then retract the coupling strut 412 and any deployed cable from the receptacle 432, and autonomously navigate away from the ACB 300 to another desired location.

Those of ordinary skill in the art will understand that the autonomous coupling system (ACS) 400, coupling devices (i.e., subsystems) 410 and 430, and all the related components described and illustrated with reference to FIGS. 21 and 22 are exemplary only and that the present disclosure contemplates utilizing various types, configurations, and/or numbers of coupling systems and components as known to those skilled in the art to autonomously couple the ASV 200 to an anchored structure at the offshore site.

Furthermore, although the above autonomous coupling system (ACS) and method is described with reference to coupling an autonomous surface vessel (ASV) to an autonomous coupling buoy (ACB), those of ordinary skill in the art would understand that the disclosed systems, subsystems, and methods could similarly be employed, based on the present disclosure, for any vessel-to vessel coupling, including, for example, coupling the ASECVs 100 to the ASV 200.

This description and the accompanying drawings that illustrate exemplary embodiments should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Furthermore, elements and their associated features that are described in detail with reference to one embodiment may, whenever practical, be included in other embodiments in which they are not specifically shown or described. For example, if an element is described in detail with reference to one embodiment and is not described with reference to a second embodiment, the element may nevertheless be included in the second embodiment.

It is noted that, as used herein, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the disclosure. For example, spatially relative terms—such as “upstream,” downstream,” “beneath,” “below,” “lower,” “above,” “upper,” “forward,” “front,” “behind,” and the like—may be used to describe one element's or feature's relationship to another element or feature as illustrated in the orientation of the figures. These spatially relative terms are intended to encompass different positions and orientations of a device in use or operation in addition to the position and orientation shown in the figures. For example, if a device in the figures is inverted, elements described as “below” or “beneath” other elements or features would then be “above” or “over” the other elements or features. Thus, the exemplary term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the systems may include additional components that were omitted from the diagrams and description for clarity of operation. Accordingly, this description is to be construed as illustrative only and is for the purpose of teaching those skilled in the art the general manner of carrying out the systems and methods of the present disclosure. It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present disclosure.

It is to be understood that the particular examples and embodiments set forth herein are non-limiting, and modifications to structure, dimensions, materials, and methodologies may be made without departing from the scope of the present disclosure. Other embodiments in accordance with the present disclosure will be apparent to those skilled in the art from consideration of the specification and practice of the invention disclosed herein. It is intended that the specification and examples be considered as exemplary only, with being entitled to their full breadth of scope, including equivalents.

1-46. (canceled)

47. A method for generating hydrogen, the method comprising:
producing AC electric current from a hydroelectric turbine deployed under water;
converting the AC electric current into DC electric current;
applying the DC electric current to an electrolyzer positioned above water at a site of the hydroelectric turbine; and
generating hydrogen via the electrolyzer.

48. The method of claim 47, further comprising collecting liquefied hydrogen at the site of the hydroelectric turbine.

49. The method of claim 48, further comprising distributing the collected liquefied hydrogen to one or more onshore sites.

50. The method of claim 47, further comprising:
collecting a hydrogen gas at the site of the hydroelectric turbine; and
shipping the hydrogen gas from the site of the hydroelectric turbine to an onshore site via one or more cryogenic tankers.

51. A method for generating and distributing hydrogen, the method comprising:
coupling one or more autonomous surface energy collection vessels to a platform floating in a body of water, wherein each of the one or more autonomous surface energy collection vessels supports an electrical energy generation system and wherein the platform supports an electrolyzer;
generating electrical energy via each electrical energy generation system of the one or more autonomous surface energy collection vessels;
using the generated electrical energy to operate the electrolyzer supported by the platform; and
generating hydrogen gas via the electrolyzer.

52. The method of claim 51, further comprising:
liquefying the generated hydrogen gas via a cryogenic liquefaction system supported by the platform; and
shipping the liquefied hydrogen from the platform to an onshore site via one or more cryogenic tankers.

53. The method of claim 52, wherein the platform is a semi-submersible platform or on an autonomous surface vessel.

54. The method of claim 53, further comprising removably coupling the autonomous surface vessel to a moored buoy.

55. The method of claim 51, further comprising:
navigating at least one of the one or more autonomous surface energy collection vessels to a moored buoy;
linking a first coupling device on the at least one of the one or more autonomous surface energy collection vessels with a second coupling device on the moored buoy;
exchanging position data between the first and second coupling devices; and
engaging a first portion of an interlock system on the first coupling device with a second portion of an interlock system on the second coupling device to secure the at least one of the one or more autonomous surface energy collection vessels to the moored buoy without any human intervention.

56. The method of claim 55, wherein linking the first coupling device with the second coupling device comprises establishing a short-range radio link between the first and second coupling devices.

57. The method of claim 55, wherein exchanging position data between the first and second coupling devices comprises monitoring an approach speed, a distance, and a direction of the at least one of the one or more autonomous surface energy collection vessels.

58. The method of claim 55, wherein engaging the first portion of the interlock system with the second portion of the interlock system comprises engaging a coupling strut on the first coupling device with a receptacle on the second coupling device.

59. The method of claim 55, wherein the at least one of the one or more autonomous surface energy collection vessels is configured to carry and deploy one or more hydroelectric turbines.

60. The method of claim 51, wherein coupling the one or more autonomous surface energy collection vessels to the platform comprises coupling a plurality of autonomous surface energy collection vessels to each other in a chain.

61. The method of claim 51, wherein the electrical energy generation system comprises at least one of a hydroelectric turbine, a wind turbine, or a solar panel.

62. The method of claim 51, further comprising uncoupling one or more of the autonomous surface energy collection vessels from the platform and moving the one or more autonomous surface energy collection vessels to a new location.

63. A system for generating, collecting, and distributing hydrogen, the system comprising:
a platform configured to be deployed in a body of water and to support equipment above the body of water;
an electrolyzer supported by the platform; and
one or more autonomous surface energy collection vessels configured to couple to the platform via a cable configured to transmit electrical energy, each of the one or more autonomous surface energy collection vessels comprising an electrical energy generation system configured to generate electrical energy for transmission to the electrolyzer via the cable,
wherein the electrolyzer is configured to generate hydrogen gas from the electrical energy.

64. The system of claim 63, wherein the one or more autonomous surface energy collection vessels comprises a plurality of autonomous surface energy collection vessels configured to couple to each other in a chain of coupled together autonomous surface energy collection vessels.

65. The system of claim 63, wherein the electrical energy generation system comprises at least one of a hydroelectric turbine, a wind turbine, or a solar panel.

66. The system of claim 63, further comprising a cryogenic liquefaction system supported by the platform, the cryogenic liquefaction system being configured to liquefy the hydrogen gas.

67. The system of claim 66, further comprising storage tanks supported by the platform, the storage tanks being configured to collect the liquefied hydrogen.
